(19) United States
(12) Patent Application Publication
(10) Pub. No.: US 2024/0415319 A1
(43) Pub. Date: Dec. 19, 2024

(54) FILTER BASKET TAMPER

(71) Applicants: Sauro Dall’Aglio, Sammamish, WA (US); Angelo Dall’Aglio, Bologna (IT)

(72) Inventors: Sauro Dall’Aglio, Sammamish, WA (US); Angelo Dall’Aglio, Bologna (IT)

(21) Appl. No.: 18/702,778

(22) PCT Filed: Oct. 18, 2022
(86) PCT No.: PCT/US2022/047049

§ 371 Date: Apr. 18, 2024

Related U.S. Application Data
(60) Provisional application No. 63/256,918, filed on Oct. 18, 2021.

(51) Int. Cl. A47J 31/44

(52) U.S. Cl. CPC A47J 31/44

(57) ABSTRACT

A filter basket for a beverage machine includes a sidewall and a strainer portion. The filter basket forms a brew chamber into which ground coffee or other products are added. The brew chamber is defined by a tapered sidewall, a strainer surface, and a smooth contour between the tapered sidewall and the strainer surface. A tamper is configured with a correspondingly tapered sidewall that allows the tamper to fit within the brew chamber to apply pressure to coffee grounds contained therein. The tapered tamper is configured to mimic the shape of the brew chamber to allow intimate contact and a better match between the tamper head sidewall and the sidewall of the brew chamber creating a more uniform puck.

### BACKGROUND

The field of the present disclosure is related to extraction of compounds from plant materials, such as coffee beans, pods, tea leaves and any type of powder or grinded-triturate compounds and more specifically, to a reusable filter basket for use with extraction equipment.

Prior methods and apparatuses of extracting compounds can result in less than ideal extraction conditions caused by uneven material distribution of material within the extraction chamber, uneven pressure within the extraction chamber, and uneven liquid flow characteristics, which results in inconsistent extractions, wasted material, and less than ideal flavors from the extracted compounds.

While extraction of compounds from plant materials is possible from current apparatuses and methods, it would be desirable to provide improvements that result in more consistent extractions, and other features that will become apparent from the following description.

### SUMMARY

According to some embodiments, a beverage machine filter basket includes a circumferential rim; a tapered or constant-diameter sidewall depending from the rim; a funnel region depending from the tapered sidewall, the funnel region having a first diameter adjacent the tapered sidewall, and a second diameter spaced from the first diameter, the second diameter smaller than the first diameter; a curved transition between the tapered sidewall and the funnel region; and a strainer having a plurality of apertures formed therethrough. A tamper having a tapered sidewall may be used to compact the coffee within the tapered filter basket. A tapered tamper will more closely cooperate with filter basket having a tapered sidewall to result in a more compacted coffee prior to extraction.

In some embodiments, the filter basket has a central axis and the tapered sidewall forms an angle with respect to the central axis. The angle may be less than 20 degrees, or less than about 15 degrees, or less than about 10 degrees in some embodiments. The tamper may have the same tapered sidewall angle to nest within the filter basket. In some instances, the curved transition between the tapered sidewall and the funnel region has a radius of curvature of greater than 0.25 mm and less than 20 mm. In some instances, the radius of curvature is between about 0.25 mm and 4 mm, or may be between 3 mm and 4 mm. In some cases, the radius of curvature is about 1 mm, 1.5 mm, 2 mm, 3 mm or 4 mm.

In some embodiments, the strainer defines a curved surface, which may be concave when viewed from the inside of the filter basket. The curved surface may have a radius of curvature that is greater than an overall height of the filter basket. In some instances, the plurality of apertures are arranged within a bounded area that is less than 90% of the surface area of the strainer. For example, where the strainer surface forms a circle when viewed from the top, an arrangement of the apertures fits within an area that is less than 90% of the overall surface area of the strainer. In other words, the apertures are not formed throughout the entire strainer surface area, but are limited to an area less than the full surface area of the strainer. In some cases, the plurality of apertures are arranged within a bounded area that is less than the entire area of the strainer, such as less than 80%, or 70%, or 60%, or 50% of the surface area of the strainer.

In some embodiments, the tapered sidewall, funnel region, and strainer together form a brew chamber. In use, material (e.g., ground coffee beans) can be placed into the brew chamber. In some examples, the brew chamber has a diameter that continually reduces in size from a top of the filter basket adjacent the rim to a bottom of the strainer. A tamper may be used to compress or compact the material within the brew chamber. The tamper may have a tapered sidewall to coincide with the sidewall of the filter basket.

According to some embodiments, a beverage machine filter basket includes a circumferential rim, a tapered sidewall depending from the circumferential rim, and a strainer depending from the tapered sidewall, the strainer forming a curved surface. A tamper may have a tapered sidewall configured to fit within the filter basket.

In some instances, the tapered sidewall of the filter basket and/or the tamper continuously tapers from a first diameter to a second diameter, the second diameter being less than the first diameter. A plurality of apertures may be formed within the curved surface of the strainer. In some cases, the plurality of apertures are arranged in a pattern, the pattern having a radius less than 90% of the radius of the strainer.

In some embodiments, the tapered sidewall and the strainer form a brew chamber, and the brew chamber may continuously narrow from a first diameter adjacent the rim, to a point at the center of the strainer. The tamper may have a corresponding tapered sidewall such that the tamper can fit within the brew chamber. The tamper may additionally include a handle protruding from an upper surface of the tamper that may be configured to allow a barista to grasp the handle and apply compacting pressure through the tamper and to the coffee beans within the brew chamber.

The embodiments described herein provide numerous advantages over prior filter designs for use in coffee extraction processes. For example, one notable drawback of current systems is the frequent channeling, where a high-pressure fluid stream finds or creates a path of least resistance through the coffee puck, thereby resulting in a volume of pressurized water that makes very little (or no) contact with the ground coffee. The result is non-uniform extraction, an inefficient extraction, and a less than ideal beverage. The embodiments described herein reduce some of the internal flex and backward fluid pressure waves that have a tendency to disrupt the coffee puck and create channeling. The embodiments described herein further smooth the fluid pressure waves and improve consistency and homogeneity of extracted beverages.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIGS. 1A and 1B show a handle for a tamper, in accordance with some embodiments;

FIGS. 2A and 2B show a tamper head from a side view, in accordance with some embodiments;

FIG. 3 illustrates a perspective view of a tamper showing a tamper handle and a tamper head, in accordance with some embodiments;

FIG. 4 illustrates a perspective view of a tamper showing a tamper handle and a tamper head, in accordance with some embodiments; and

FIG. 5 illustrates a tamper head, in accordance with some embodiments

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

According to some embodiments, the systems and methods described herein are useful for extraction of compounds from plant materials, and in some cases, are useful for extracting compounds from coffee beans using water as the solvent.

Coffee beans are typically roasted in order to reduce the complex sugars and to caramelize some of the simple sugars within the coffee bean. In some cases, roasting the coffee beans also breaks down acids in the coffee bean. In some instances, coffee beans are roasted to balance the acidity and sweetness of the bean in order to produce pleasing aromas and flavors once the compounds are extracted from the coffee beans using hot water.

In some instances, the coffee beans are ground and used in an extraction process to produce espresso, or any of a number of other coffee or espresso-based beverages, such as cappuccino, macchiato, latte, cortado, americano, mocha, and other coffee beverages, to name a few examples.

In a typical espresso making process, coffee beans are ground and subjected to near-boiling hot water (e.g., about 200° F. or about 93° C.) at a pressure of about 130 psi (9bar). As the water passes through the ground coffee beans at pressure, the water dissolves some of the compounds from the coffee bean and the result is a dark, rich, hot coffee-based drink.

An espresso machine brews coffee by forcing pressurized water through a “puck” of ground coffee and a filter. The coffee puck is formed by adding a desired amount of ground coffee to a portafilter and tamping the ground coffee to get a distribution and density within the portafilter. The portafilter is a device with a handle and a filter basket therein. The filter basket holds the coffee puck and the handle is used to secure the portafilter to the coffee machine to thereby form a brewing chamber within the filter basket.

The espresso machine heats water and forces it through the coffee puck and the filter basket and out of the portafilter into a beverage cup. In some embodiments, the filter basket comprises a plurality of filter holes through which the pressurized hot water exits the filter basket and is then directed to a beverage cup. The process of extracting an espresso-based drink in this manner may be referred to as “pulling a shot.”

Many factors combine to influence the quality of the extracted beverage. For example, the particulate size of the ground coffee bean, the quality of the bean, the roast of the coffee bean, the heat of the water, the time that the water is in contact with the ground coffee, the distribution of the ground coffee within the filter basket, and the compressed density of the ground coffee beans within the filter basket, among others. Notably, several of these variables are influenced, at least in part, by the filter basket itself.

For example, the filter basket is shaped to form a chamber into which the ground coffee beans are inserted and tamped to provide the coffee puck. The filter basket additionally has a plurality of holes that allow the extracted compounds dissolved into the water to leave the filter basket. The shape of the filter basket controls a pressure profile of the pressurized water forced through the puck. The holes within the filter basket control, to some degree, the flow rate of the water out of the filter basket, thus determining the time that the water is in contact with the ground coffee. Therefore, the configuration of the filter basket can play a dramatic role in the quality of the shot. Moreover, the configuration of the tamper may affect the formation of the coffee puck. In some cases, the tamper is shaped to coordinate with the shape of the filter basket.

The time that the water is in contact with the puck has a dramatic impact on the flavor of the shot. Typically, the first compounds extracted out of the ground coffee are acids and fats, which contribute to a salty and sour taste in the shot. Where the water remains in contact with the ground coffee long enough to continue extraction, sugars become extracted next which contribute sweetness to the extracted shot. Finally, if the extraction process is allowed to continue, plant fibers are broken down and extracted, which contribute a dry, bitter flavor to the shot.

By modifying the time that the heated water is in contact with the ground coffee beans, the flavor of the shot is altered along a continuum from sour, to sweet, to bitter. In most extraction machines, the extraction time is directly related to the pressure of the heated water in combination with the configuration of the filter basket, and more particularly, the shape of the filter basket, the arrangement and configuration of the holes in the filter basket, and the density of the coffee puck. The particulate size of the ground coffee also plays a part in the extraction time, and this is another variable that can be adjusted to modify the flavors in the shot based on personal preference.

A shot of espresso may be defined by the quality of extraction and the strength of the beverage. In some cases, strength relates to the quantity of dissolved compounds in the beverage. For example, espresso may contain about 7% to 12% dissolved solids and about 88%-93% water. Personal preference may alter the desired dissolved solids, but this range is typical for many espresso-based drinks. The strength of the beverage is also related to the extraction. For example, the volume of water and the time of extraction determine the strength of the beverage.

While each individual consumer may experiment with the above-described variables to determine his own favorite shot, there are some characteristics that may be widely applicable to many coffee drinkers. For example, one undesirable occurrence when pulling a shot is spurting, in which the pressurized water finds a path of least resistance through the coffee puck and a volume of water exits the filter basket with very low solids and is typically seen spraying from the filter basket indicating that the pressurized water stream has not had sufficient time for extraction. This phenomenon may be a result of uneven tamping, uneven grounds distribution, or channeling in which the pressurized water finds or creates a channel through the puck.

In some embodiments, a filter basket can influence the quality of the extraction by altering the flow characteristic of the extraction water. Several advantages will become readily apparent by the following description of improved filter baskets that have unique and novel pozzetto shapes and configurations. As used herein, the term “pozzetto” refers to the internal shape of the bottom of the filter basket, where the strainer is and may be formed as a depression compared to the internal level of the tamping area. In some embodiments, a pozzetto may be an alto, or a relatively shallow strainer, or may be described as basso, which refers to a relatively deep strainer. The tamper may be similarly sized and shaped to conform to the internal shape and size of the pozzetto. In some cases, the filter basket and the tamper cooperate to provide a positive stop that determines a maximum distance the tamper may extend into the filter basket. For instance, the filter basket may define a shoulder with a reduced diameter that interferes with the lower surface of the tamper to inhibit the tamper from extending into the basket any further. The positive stop may aid in providing a repeatable compression of the coffee grounds within the filter basket.

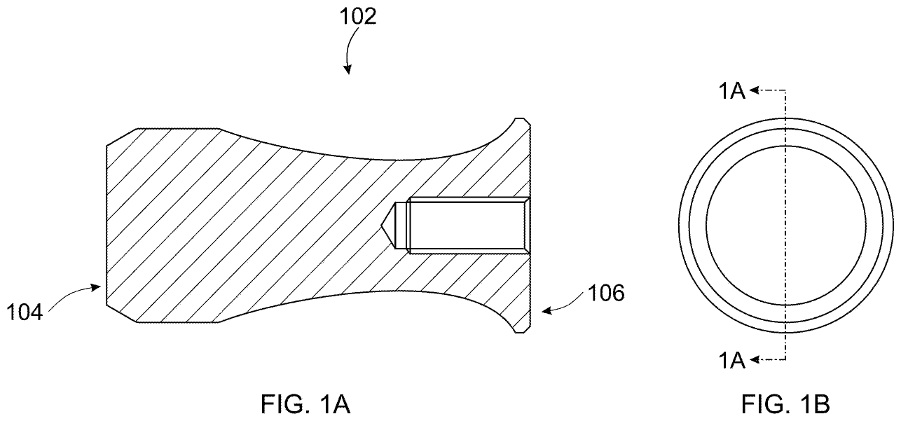

With reference to FIGS. 1A and 1B, a handle 102 for a tamper may be formed with a circular cross section and defining different diameters along the length of the handle. For instance, the handle may include a first end 104 and a second end 106. The first end 104 and second end 106 may have different diameters and the length in between the first and second ends may have a profile in which the handle 102 may be wider or narrower at different areas along its length. The handle may be formed for comfort, such as by shaping the handle to fit comfortably within the hand of a user. The handle may be formed of any suitable material, such as wood, metal, alloys, plastic, composite materials, or any combination of materials. FIG. 1A is a cross-sectional view of FIG. 1B as shown by section line 1A-1A. While the handle is shown having a circular cross-section, it should be apparent than any cross-sectional shape could be used to provide a handle that allows a user to manipulate the handle and tamper in order to compress a puck within a filter basket.

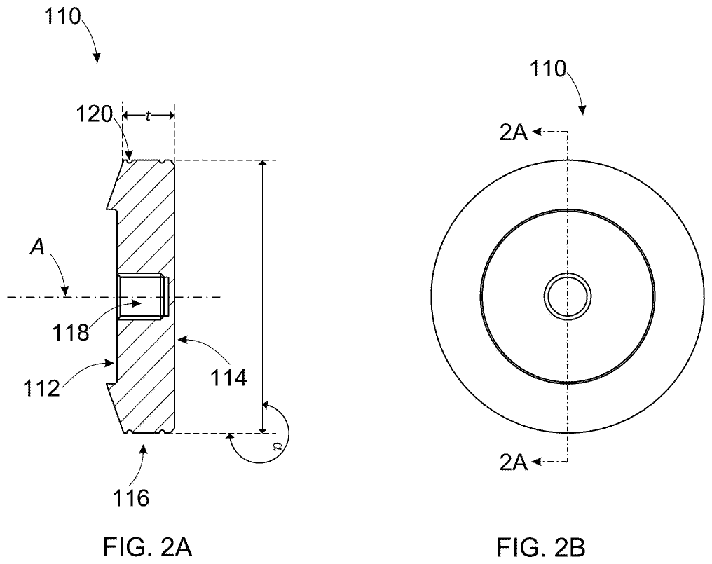

FIGS. 2A and 2B illustrate a head 110 of a tamper in accordance with some embodiments. The head 110 may be generally puck shaped, that is, having a diameter D1 that is greater than a thickness/of the head 110. The dimensions the diameter ID1, thickness t, radii, and the like, can be any suitable dimensions that create a tamper head that fits within a filter basket and can compress the coffee grounds therein to create a puck.

The head 110 may have a upper surface 112, a bottom surface 114 and a thickness t therebetween. The thickness/may be defined by a sidewall 116. In some cases, the sidewall 116 is not perpendicular with the bottom surface 114. In other words, a plane defined by the bottom surface 114 and the sidewall form an angle therebetween that is not 90°. Put another way, the head 110 may have an axis A extending from the upper surface 112 to the bottom surface 114 and the surface of the sidewall is not parallel to the axis.

Similarly, in some embodiments, a filter basket has an axis, and one or more sidewalls are not parallel to the axis. In some instances, each of the sidewalls of the filter basket is not parallel to the axis. In other words, when viewed from the side, none of the surfaces that form the brew chamber are vertical, but rather, form an angle relative to the axis that is greater than zero. In some cases, the tamper sidewalls are parallel to the filter basket sidewalls. The sidewalls 116 may be formed with one or more annular grooves 120. The grooves may aid in inserting and removing the tamper head 110 from the filter basket.

In some embodiments, the bottom surface 114 defines a shape other than a plane. For example, the bottom surface 114 need not be flat, but rather, can be convex, concave, stepped, textured or form some other shape. In some cases, the bottom surface may be formed with an image, text, graphic, or logo that embosses or debosses an impression into the coffee puck. For example, a company logo may be formed as a boss or pocket in the bottom surface 114 and when the tamper head compresses a coffee puck, the company logo is left protruding or is recessed in the compressed coffee puck.

In some examples, the sidewalls of the tamper mimic the tapered sidewall of the filter basket. As illustrated in FIG. 2A, an external angle a between the bottom surface 114 and the sidewall 116 may be less than 270°, such as 269°, or 268°, or 267°, or 266°, or 265° or some other suitable angle.

In some embodiments, the tamper head 110 may have a threaded hole 118, which may be a stopped hole. The threaded hole 118 may be configured to receive a threaded fastener, such as a bolt. In some cases the handle 102 has a threaded boss that protrudes from the bottom of the handle, and the threaded boss may be received by the threaded hole 118 of the tamper head 110 to allow the tamper head 110 to thread onto the handle. In other cases, a threaded fastener may be affixed to the tamper head 110, which may then be threaded into the handle 102, as desired, to affix the tamper head 110 to the handle 102. In some examples, the handle 102 is permanently affixed to the tamper head 110, and in some cases may be formed integrally.

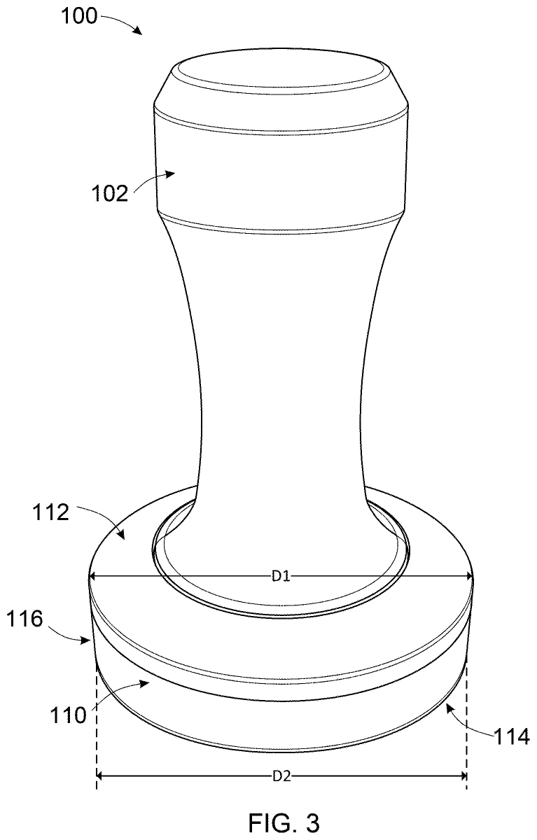

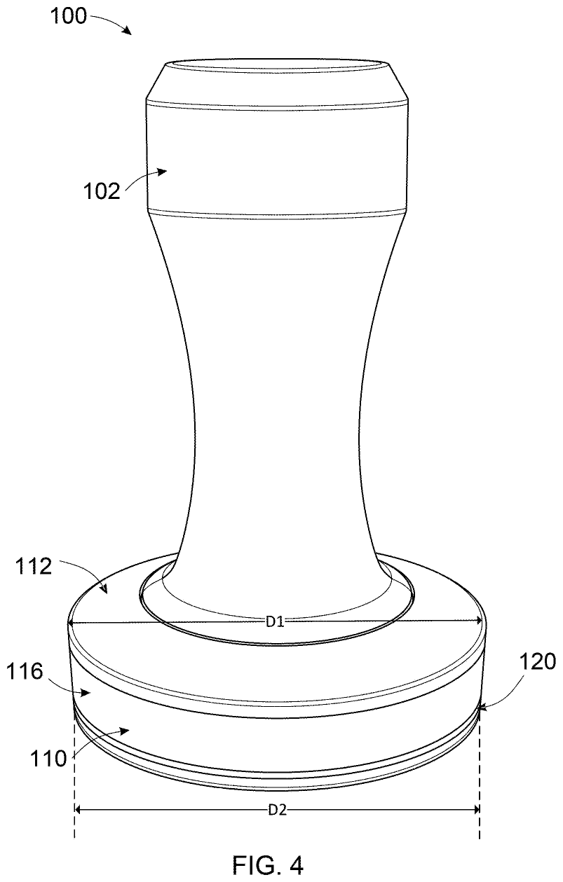

FIGS. 3 and 4 illustrate examples of a tamper 100 in which the handle 102 is secured to the tamper head 110. The tamper 100 may be formed of any suitable material or combination of materials. In some cases, the tamper head 110 may be formed of stainless steel. The handle may be formed of wood, plastics, metal, such as stainless steel, or a combination of materials.

As shown in FIG. 3, the tamper head has a diameter D1 near its upper surface 112 and a diameter D2 near its bottom surface 114. In some cases, diameter D1 is equal, or nearly equal, to diameter D2. In these embodiments, the tamper head 110 may have vertical sidewalls 116. Moreover, in some cases, the sidewall 116 may be smooth with minimal or no grooves or protrusions, as illustrated.

As shown in FIG. 4, in some embodiments the upper surface 112 may have a first diameter D1 and the bottom surface 114 may have a second diameter D2 wherein D2<D1. In other words, the sidewalls 116 are not parallel to a central axis extending through the handle 102 and tamper head 110. Moreover, the sidewall 116 may have grooves formed therein, which may be formed to reduce the surface area contact with a filter basket.

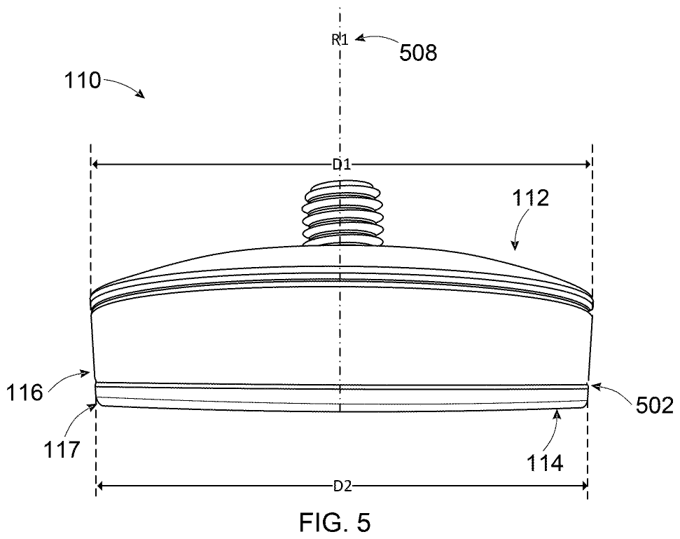

With reference to FIG. 5, the sidewall 116 of the tamper head 110 may taper uniformly from a first diameter D1 to a second diameter D2 that is smaller than the first diameter. That is, the sidewall 116 may have a first diameter adjacent the upper surface 112 that is larger than a diameter of the sidewall 116 adjacent the bottom surface 114. The sidewall 116 may have a uniform taper, or may have one or more annular grooves 502 about the periphery of the tamper head. The interface of the sidewall 116 and the bottom surface 114 may have a radius 117, which in some cases is between about 0.0025″ (0.06 mm) and 0.25″ (6.35 mm).

In some cases, the tamper head 110 defines a tapered sidewall that may be configured to fit within a filter basket having a correspondingly shaped taper. The bottom surface 114 may have a radius R1 of curvature 508 such that the bottom surface is not planar. In some cases, the bottom surface 114 may be semi-spherical. The radius of curvature 508 may be on the order of 5″ (127 mm), 10″ (254 mm), or larger.

In some embodiments, the tamper head 110 has a first width near its top surface that is greater than a width nearer the bottom surface. For clarity, the bottom surface is the surface configured to contact coffee grounds for tamping and the upper surface is opposite the bottom surface. In some cases, the sidewall between the top surface and bottom surface is uniformly tapered, while in other cases, the sidewall may curve as it extends from the top surface to the bottom surface. In some cases, the tamper may have a shape other than circular. For example, the tamper head may have any suitable shape, such as square, rectangular, ovoid, or any regular polygonal shape, such as a pentagon, hexagon, heptagon, octagon, or other shape.

In some cases, the sidewall may be stepped such as having portions that are a constant diameter (or width in the case of a non-circular tamper head) wherein more than one portion have different diameters.

In some examples, the tamper head may be affixed to a handle, as described herein, or may be coupled to a machine. In some cases, a machine may automatically or manually apply the tamping force and the tamper head may be coupled to the machine to allow the machine to manipulate the tamper head. For example, a machine may include an actuator that moves the tamper head to compress coffee grounds. Alternatively, or additionally, a machine may couple to the tamper head, and a manual lever may be actuated in order to manipulate the tamper head to compress the coffee grounds, which may be referred to as a mechanical and/or manually driven tamping device. In some cases, the tamper head may be coupled to a lever mechanism that may be manually or automatically manipulated to compress the coffee grounds with the tamper head. In some embodiments, the tamper head and/or tamper may be coupled to an electrically driven mechanical tamping machine that uses electricity and one or more driven elements to drive the tamper in order to compress coffee grounds.

The transition from the sidewall 116 to the bottom surface 114 may include a radius 117, such as anywhere from about 0.0025″ (0.06 mm) and 0.25″ (6.35 mm). The radius may be convex or concave. In some examples, the transition from the sidewall to the bottom surface forms a sharp angle with little to no radius. The tamper head may have any suitable diameter or combination of diameters, which may be on the order of about 42 mm, 48 mm, 51 mm, 55 mm, 58 mm, 60 mm or any other suitable size, such as less than 42 mm, or greater than 60 mm, or a diameter between about 30 mm and 80 mm. The upper surface 112 may have one diameter and the bottom surface 114 may have a second diameter different from the first diameter.

The upper surface 112 of the tamper head may be any suitable shape, such as generally flat, tapered, curved, angled, or have any other suitable surface shape to allow the tamper head 110 to couple to a handle, a mechanism, or a machine.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

As used herein, the term “or” is used inclusively to refer items in the alternative and in combination. As used herein, characters such as numerals refer to like elements, oftentimes with the first numeral corresponding to a figure number, and the remaining numerals corresponding to like elements in other figures.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A tamper for compressing coffee grounds in a filter basket, comprising:
a handle; and
a tamper head coupled to the handle, the head having a first surface and a second surface and a sidewall therebetween; and
wherein the sidewall tapers from a first diameter adjacent the first surface to a second diameter adjacent the second surface, the second diameter being smaller than the first diameter.

2. The tamper as in claim 1, wherein the first surface is coupled to the handle and the second surface is opposite the first surface.

3. The tamper as in claim 1, further comprising a transition between the sidewall and the second surface.

4. The tamper as in claim 3, wherein the transition defines a radius.

5. The tamper as in claim 4, wherein the radius is between 0.06 mm and 6.35 mm.

6. The tamper as in claim 1, wherein the sidewall comprises one or more annular grooves formed in the sidewall.

7. The tamper as in claim 1, wherein the sidewall taper is a constant.

8. The tamper as in claim 1, wherein the handle is connected to the tamper head by a threaded connection.

9. The tamper as in claim 8, wherein the threaded connection is a threaded boss formed integrally with the tamper head and the handle includes a threaded recess for receiving the threaded boss.

10. The tamper as in claim 8, wherein the threaded connection is a threaded boss formed in the handle and the tamper head includes a threaded recess for receiving the threaded boss.

11. The tamper as in claim 1, wherein the second surface defines a radius of curvature.

12. The tamper as in claim 1, wherein the second surface is semi-spherical.

13. The tamper as in claim 1, wherein the tamper is affixed to a mechanical tamping device.

14. The tamper as in claim 13, wherein the mechanical tamping device is electrically driven.

15. The tamper as in claim 13, wherein the mechanical tamping device is manually driven.
